(19) United States
(12) Patent Application Publication
(10) Pub. No.: US 2015/0008743 A1
(43) Pub. Date: Jan. 8, 2015

(54) Power Supply System

(71) Applicant: Kabushiki Kaisha Toshiba, Tokyo (JP)

(72) Inventors: Misao Kimura, Tokyo (JP); Yasuhiro Noro, Tokyo (JP); Hideki Hayashi, Kanagawa-ken (JP); Yoshiaki Hasegawa, Tokyo (JP); Yoshio Ebata, Tokyo (JP)

(21) Appl. No.: 13/935,223

(22) Filed: Jul. 3, 2013

(51) Int. Cl. H02J 1/00

(52) U.S. Cl. CPC H02J 1/00
USPC 307/52

(57) ABSTRACT

A power supply system comprises: a second electric power converter that converts power discharged by electric power storage means to AC power and that converts charging power to the electric power storage means to DC power; a second current detector that detects the current that is output from the second electric power converter; an electric characteristic computation section that calculates the output current I_{Gref} and the electrical output torque Te of a virtual power generator, based on the voltage V_{T}, angular frequency ω and voltage set value V_{ref} of a first electric power converter and the second electric power converter, and their connection point (point a) with the power system; a rotor speed computation section.

### FIELD

Embodiments described herein relate to a power supply system.

### BACKGROUND

In recent years, studies have been made aimed at reduction of the amount of carbon-dioxide emission (or carbon footprint) of power supply systems by installing power generation equipment utilizing renewable energy which does not generate greenhouse gases during power generation. However, in the case of power generation utilizing renewable energy, control of the amount of power supplied is more difficult than in a power generation system using for example thermal power generation, so achievement of stable power supply is desired.

For example, stable power supply is more difficult in the case of solar power generation than in a conventional power generation system using for example thermal power because of long-period fluctuations and short-period fluctuations in the amount of solar radiation. As methods of solving this problem, there has been proposed a power supply system in which the active power that is output from the system is controlled to a fixed value, by employing a combination of power generation equipment using renewable energy with a power storage device, exemplified by a storage battery, or a method in which short-period fluctuations of output of the power generation equipment are suppressed by utilizing renewable energy. As technology that is related to the foregoing, there may be mentioned Laid-open Japanese Patent Application Number Tokkai 2007-318833 (hereinafter referred to as Patent Reference 1).

In the case of a synchronous power generator, such as a thermal power generator, a contribution to stability of the system frequency is obtained due to the fact that, when the system frequency fluctuates, there is a latent action tending to suppress such fluctuation; furthermore, a governor is provided, so that, when the system frequency fluctuates, the amount of power generated is adjusted so as to suppress such fluctuation. In contrast, in the case of a power supply system in which power generation equipment utilizing renewable energy is combined with a power storage device, such a frequency regulation action as described above that occurs in the case of a synchronous power generator when the system frequency fluctuates is absent: consequently, when a large amount of power is introduced into the system, difficulty in stabilizing the system frequency may be anticipated.

This embodiment of the present invention was made in order to solve the problem described above, its object being to provide a power supply system that is easy to manage from the point of view of monitoring and control of the power system as a whole.

### Means for Solving the Problem

According to the embodiment, there is provided a power supply system comprising:

electric power storage means;

a second electric power converter that converts power discharged by said electric power storage means to AC power and that converts charging power to said electric power storage means to DC power;

a second current detector that detects the current that is output from said second electric power converter;

a first electric power converter that converts DC power to AC power and supplies said AC power;

an electric characteristic computation section that calculates an output current and an electrical output torque of a virtual power generator, based on a voltage of a connection point between said power conversion and the power system, an angular frequency and a voltage set value;

a rotor speed computation section that calculates said angular frequency of said virtual power generator, based on said electrical output torque of said virtual power generator calculated by said electrical characteristic computation section and an output target value for active power; and

a second power conversion controller that controls said second electric power converter in accordance with the difference between the current that is output to the power system from said first electric power converter and the output current of said virtual power generator.

### BRIEF DESCRIPTION OF THE DRAWINGS

FIG. 1 is a block diagram showing an example layout of a power supply system according to a first embodiment;

FIG. 2 is a view showing an example layout of a second power conversion controller as shown in FIG. 1;

FIG. 3 is a view showing an example layout of a mechanical output computation section as shown in FIG. 1;

FIG. 4 is a view showing an example layout of a rotor speed computation section as shown in FIG. 1;

FIG. 5 is a view showing an example layout of a field voltage computation section as shown in FIG. 1;

FIG. 6 is a block diagram showing another example layout of a power supply system according to the first embodiment;

FIG. 7 is a view given in explanation of an example of a method of finding a current instruction value;

FIG. 8 is a block diagram showing a layout diagram of a power supply system according to a second embodiment;

FIG. 9 is a view showing an example layout of an internal voltage computation section as shown in FIG. 8;

FIG. 10 is a block diagram showing an example layout of a power supply system according to a third embodiment; and

FIG. 11 is a block diagram showing an example layout of a power supply system according to a fourth embodiment.

### DETAILED DESCRIPTION

Embodiments are described below with reference to the drawings.

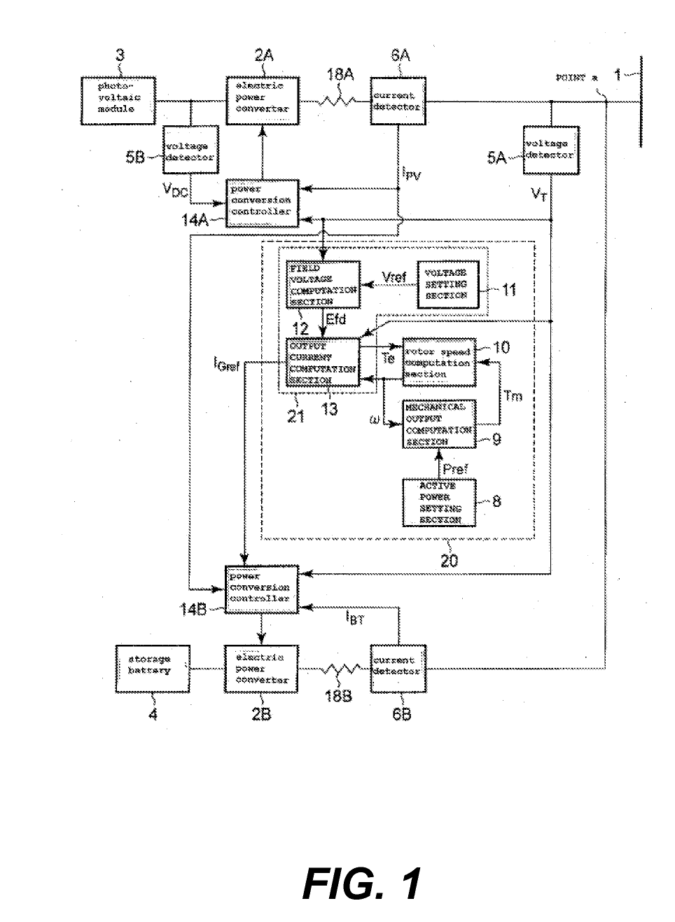

FIG. 1 is a diagram showing an example layout of a power supply system according to a first embodiment.

A power supply system according to the present embodiment is applied to a photovoltaic system, as an example of power generation equipment that utilizes renewable energy. Apart from photovoltaic systems, as power generation equipment utilizing renewable energy, the embodiment may also be applied to power generation equipment such as for example wind power generation systems, geothermal power generation systems, wave, tidal power or ocean current power generation systems and the like.

The power supply system according to the present embodiment comprises: a photovoltaic module 3, a first electric power converter 2A, a first voltage detector 5A, a second voltage detector 5B, a first current detector 6A, a first power conversion controller 14A, a second electric power converter 2B, a second current detector 6B, a power generator characteristic computation unit 20, an storage battery (electric power storage means) 4, and a second power conversion controller 14B. The combination of the photovoltaic module 3, first electric power converter 2A, first power conversion controller 14A, a smoothing reactor 18A, second voltage detector 5B, and first current detector 6A constitutes an example of a solar power generation system.

The first voltage detector 5A is connected in the vicinity of the connection point (point a) of the first electric power converter 2A, the second electric power converter 2B and the power system 1. This first voltage detector 5A detects the voltage at the connection point of the first electric power converter 2A, the second electric power converter 2B, to be described, and the power system 1.

The second voltage detector 5B is arranged in the DC circuit between the photovoltaic module 3 and the first electric power converter 2A, and detects the DC voltage V_{DC} of this DC circuit. The second voltage detector 5B outputs this detected DC voltage V_{DC} to the first power conversion controller 14A.

The first current detector 6A is arranged between the power system 1 and the first electric power converter 2A and detects the AC current I_{PV} that is output from the first electric power converter 2A. The first current detector 6A outputs this detected AC current I_{PV} to the first power conversion controller 14A and the second power conversion controller 14B.

The photovoltaic module 3 includes a controller whereby the output power from the photovoltaic module 3 is controlled to a maximum, depending on the solar radiation amount (MPPT control: Maximum Power Point Tracking Control); when the output power from the photovoltaic module 3 becomes large, V_{DC} becomes high and, conversely, when the output power from the photovoltaic module 3 is small, V_{DC} is low.

The first electric power converter 2A is connected with the power system 1 through the smoothing reactor 18A and converts the DC power generated by the photovoltaic module 3 to AC power. The first electric power converter 2A operates so as to supply the power generated by the photovoltaic module 3 to the power system 1. Consequently, the output power of the first electric power converter 2A constitutes power that reflects fluctuation of the power generation amount of the photovoltaic module 3 in accordance with the fluctuation of the solar radiation amount. Specifically, the output power of the first conversion device 2A becomes large when the output power from the photovoltaic module 3 becomes large. Contrariwise, when the output power from the photovoltaic module 3 becomes small, the output power from the first electric power converter 2A becomes small. In this embodiment, the electric power converter 2A is a so-called two way inverter, that outputs AC voltage in accordance with a control signal that is output from the first power conversion controller 14A.

The first power conversion controller 14A controls the operation of the first electric power converter 2A in accordance with the output value V_{T} of the first voltage detector 5A, the output value V_{DC} of the second voltage detector 5B and the output value I_{PV} of the current detector 6A. The first power conversion controller 14A controls the output voltage of the first electric power converter 2A using the output value V_{T} of the first voltage detector 5A and the output value I_{PV} of the first current detector 6A, so that power is output wherein the output value V_{DC} of the second voltage detector 5B is constant.

The second current detector 6B is arranged between the power system 1 and the second electric power converter 2B, so as to detect the AC current I_{BT} that is output to the power system 1 from the second electric power converter 2B. The second current detector 6B outputs the detected AC current I_{BT} to the second power conversion controller 14B.

The second electric power converter 2B is connected with the power system 1 through a smoothing reactor 18B. The second electric power converter 2B is a two way inverter, that, in accordance with a control signal that is output from the second power conversion controller 14B, converts the discharge power of storage battery 4 to AC power, which it outputs to the power system 1, and converts the charging power to the storage battery 4 to DC power.

The second power conversion controller 14B controls the operation of the second electric power converter 2B in accordance with the output value V_{T} of the first voltage detector 5A, the output value I_{BT} of the second current detector 6B, the output value I_{PV} of the first current detector 6A, and the output current I_{Gref} of the virtual power generator.

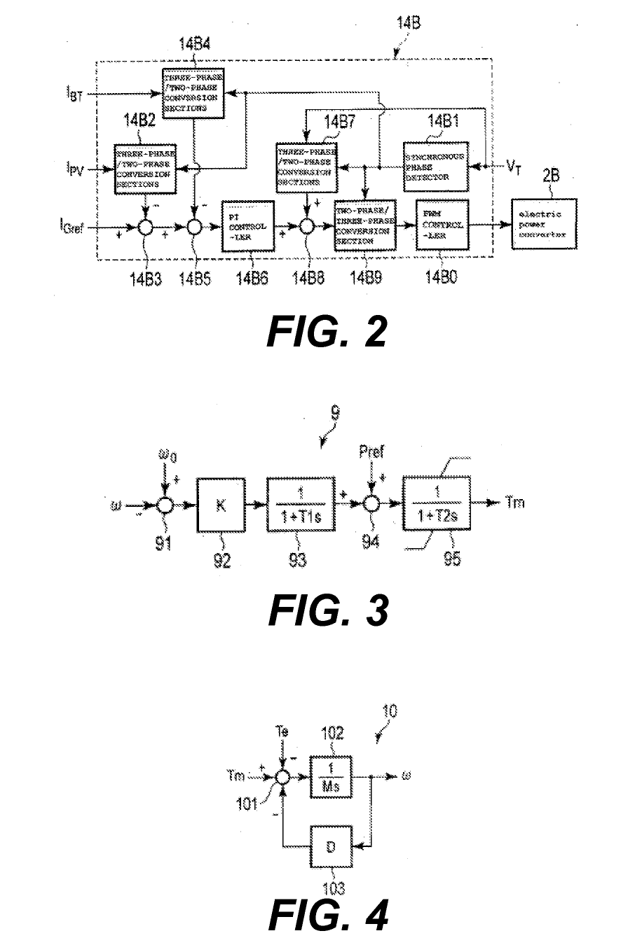

FIG. 2 is a block diagram showing a layout example of the second power conversion controller 14B. The output voltage of the second electric power converter 2B is controlled so that the output value I_{BT} of the current detector 6B and the difference of the output current I_{Gref} of the virtual power generator and the output I_{PV} of the current detector 6A are equal.

The second power conversion controller 14B comprises: a synchronous phase detector 14B1, three-phase/two-phase conversion sections 14B2, 14B4, 14B7, subtractors 14B3, 14B5, a PI controller (proportional integral control) 14B6, an adder 14B8, a two-phase/three-phase conversion section 14B9, and a PWM controller (pulse width modulation control) 14B0.

The synchronous phase detector 14B1 receives the AC voltage V_{T} detected by the first voltage detector 5A and detects synchronous phase of the three-phase AC voltage, and delivers output to the three-phase/two-phase conversion sections 14B2, 14B4, 14B7, and two-phase/three-phase conversion section 14B9.

The three-phase/two-phase conversion section 14B2 receives the AC current I_{PV} detected by the first current detector 6A and, in accordance with the phase angle received from the synchronous phase detector 14B1, converts the three-phase AC current I_{PV} to two-phase.

The three-phase/two-phase conversion section 14B4 receives the AC current I_{BT} detected by the second current detector 6B, and, in accordance with the phase angle received from the synchronous phase detector 14B1, converts the three-phase AC current I_{BT} to two-phase.

The three-phase/two-phase conversion section 14B7 receives the AC voltage V_{T} detected by the first voltage detector 5A and, in accordance with the phase angle received from the synchronous phase detector 14B1, converts the three-phase AC voltage V_{T} to two-phase.

The subtractor 14B3 receives the output current I_{Gref} of the virtual power generator and the two-phase AC current I_{PV}, and outputs the difference obtained by subtracting the current I_{PV} from the current I_{Gref} to the subtractor 14B5.

The subtractor 14B5 receives the difference that is output from the subtractor 14B3 and the two-phase AC current I_{BT}, and outputs the difference obtained by subtracting the current I_{BT} from this difference to the PI controller 14B6. Specifically, the difference that is output from the subtractor 14B5 is a value obtained by subtracting the current I_{PV} and the current I_{BT} from the current I_{Gref}.

The PI controller 14B6 receives the difference that is output from the subtractor 14B5, calculates a two-phase voltage such that this received value becomes zero, and outputs this.

The adder 14B8 receives the voltage that is output from the PI controller 14B6 and the two-phase voltage V_{T} that is output from the three-phase/two-phase conversion section 14B7, adds these, and then outputs the result to the two-phase/three-phase conversion section 14B9.

The two-phase/three-phase conversion section 14B9 receives the two-phase voltage that is output from the adder 14B8, and, in accordance with the phase angle that is received from the synchronous phase detector 14B1, converts the two-phase voltage to a three-phase voltage. This three-phase voltage that is thus output is the target value for the three-phase AC voltage to be output from the second electric power converter 2B.

The PWM controller 14B0 receives the three-phase AC voltage that is output from the two-phase/three-phase conversion section 14B9, and outputs a PWM control signal such that this received AC voltage is output from the electric power converter 2B.

The power generator characteristic computation unit 20 supplies the output current I_{Gref} for the virtual power generator. The power generator characteristic computation unit 20 comprises: an active power setting section 8, a mechanical output computation section 9 that is supplied with the output value of the active power setting section 8 and the output value of a rotor speed computation section 10, the rotor speed computation section 10 that is supplied with the output value Te of an output current computation section 13 and the output value Tm of the mechanical output computation section 9, and an electrical characteristic computation section 21.

The operation of a power generator characteristic computation unit 20 that generates the output current I_{Gref} of the virtual power generator is described below.

The active power setting section 8 acts as a simulated synchronous power generator that outputs to the power system 1 an active power set value P_{ref} that is to be output therefrom.

FIG. 3 is a block diagram showing diagrammatically an example layout of the mechanical output computation section 9.

The mechanical output computation section 9 corresponds to the control device called a governor of the synchronous power generator and is constructed for example so as to implement the control block diagram shown in FIG. 3. The mechanical output computation section 9 comprises: a subtractor 91 that outputs the difference obtained by subtracting the angular frequency ω from the fundamental angular frequency ω₀; a proportional block 92 of amplification factor K; first order lag blocks 93, 95 of time constants T1, T2; and an adder 94 that adds the output of the first order lag block 93 and the active power set value P_{ref} and outputs the sum thereof; this mechanical output computation section 9 inputs the angular frequency ω which is the output of the rotor speed computation section 10 and the active power set value P_{ref} which is the output of the active power setting section 8 and calculates and outputs a value corresponding to the mechanical output Tm of the synchronous power generator. The mechanical output Tm corresponds to the torque that is generated by for example steam energy in a thermal power generator.

If the input of the first order lag block 93 and the proportional block 92 has a positive value i.e. when the angular frequency ω drops below the fundamental angular frequency ω₀, (ω₀−ω>0), ultimately, the mechanical output Tm is increased. Conversely, if the input of the first order lag block 93 and the proportional block 92 has a negative value i.e. when the angular frequency ω rises above the fundamental angular frequency ω₀, (ω₀−ω<0)), ultimately, the mechanical output Tm is decreased. The magnitude or speed of the change in the mechanical output Tm with respect to the change in angular frequency ω is determined by the amplification factor K of the proportional block 92 and the time constants T1, T2 of the first order lag blocks 93, 95.

FIG. 4 is a block diagram showing diagrammatically an example layout of the rotor speed computation section 10. The rotor speed computation section 10 calculates the kinetic motion equation of the synchronous power generator. The rotor speed computation section 10 is constructed so as to implement for example the block diagram shown in FIG. 4. The rotor speed computation section 10 comprises a subtractor 101, integrator 102, and proportional block 103. The constant M of the integrator 102 corresponds to the inertia constant of the power generator including the turbine, and the coefficient D of the proportional block 103 corresponds to the damping coefficient.

If the mechanical output Tm is fixed, when the electrical output torque Te is decreased by for example reduction in the load of the power system 1, the input to the integrator 102 shown in FIG. 4 becomes a positive value, so, with a rate of change depending on the inertia constant M and damping coefficient D, the angular frequency ω rises. Conversely, when the electrical output torque Te is increased by for example increase in the load of the power system 1, the input to the integrator 102 becomes a negative value, so, with a rate of change depending on the inertia constant M and damping coefficient D, the angular frequency ω falls.

If the electrical output torque Te is fixed but the mechanical output Tm changes, the polarities are reversed. Consequently, if the mechanical output Tm decreases, the angular frequency ω falls, while if the mechanical output Tm increases, the angular frequency ω rises.

The rotor speed computation section 10 calculates the angular frequency ω of the synchronous power generator as described above. The mechanical output computation section 9 reduces the mechanical output Tm when the angular frequency ω rises but increases the mechanical output Tm when the angular frequency ω drops and so acts to suppress fluctuation of the angular frequency ω. The angular frequency ω calculated by the rotor speed computation section 10 is supplied to the electrical characteristic computation section 21.

The electrical characteristic computation section 21 comprises: a voltage setting section 11, a field voltage computation section 12 that is supplied with an output value V_{ref} of the voltage setting section 11 and the output value (near end voltage) V_{T} of the first voltage detector 5A; and an output current computation section 13 that is supplied with the output value (near end voltage) V_{T} of the first voltage detector 5A, the output value ω of the rotor speed computation section 10, and the output value Efd of the field voltage computation section 12.

The voltage setting section 11 outputs the voltage set value V_{ref}, which is the target value for the near end voltage V_{T} of the connection point (point a) of the power system 1.

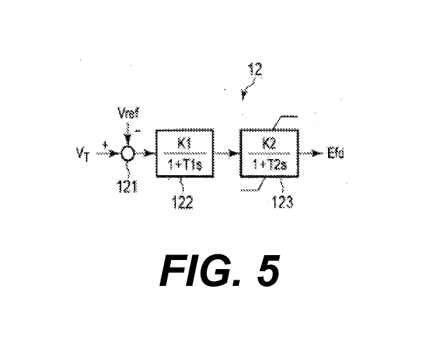

FIG. 5 is a block diagram showing diagrammatically an example layout of the field voltage computation section 12.

The field voltage computation section 12 is constructed so as to implement the control block shown for example in FIG. 5, corresponding to the excitation system of the synchronous power generator. The field voltage computation section 12 calculates a value Efd corresponding to the field voltage of the synchronous generator, in accordance with the difference (V_{ref}−V_{T}) of the voltage set value V_{ref} and the near end voltage V_{T} at the connection point (point a) obtained by the first voltage detector 5A, and outputs this to the output current computation section 13. If the near end voltage V_{T} is smaller than the voltage set value V_{ref} (V_{ref}−V_{T}>0), the first order lag input is a positive value, so the value Efd corresponding to the field voltage is increased; conversely, if the near end voltage V_{T} is larger than the voltage set value V_{ref} (V_{ref}−V_{T}<0), the first order lag input is a negative value, so the value Efd corresponding to the field voltage is decreased.

The output current computation section 13 calculates the electrical characteristic of the synchronous power generator i.e. the so-called Park's equation. The output current computation section 13 calculates the output current I_{Gref} of the virtual power generator, using as input values: the value Efd corresponding to the field voltage, which is output by the field voltage computation section 12; the angular frequency ω, which is output by the rotor speed computation section 10; and the near end voltage V_{T} of the connection point (point a) that is obtained by the first voltage detector 5A.

Represented in terms of a simplified calculation formula, the power generator output current may be found by expression (1): the real part of the result obtained by multiplying the power generator output current by the terminal voltage is the active power output, and is found by expression (2).

$$\begin{matrix}[ Math 1 ] & \\ {I}_{G} = \frac{{E}_{G} {∠δ}_{EG} - {V}_{T} {∠δ}_{VT}}{jX} & ( 1 )\end{matrix}$$

$$\begin{matrix}[ Math 2 ] & \\ {P}_{G} = \frac{{E}_{G} \cdot {V}_{T}}{X} sin ( {δ}_{EG} - {δ}_{VT} ) & ( 2 )\end{matrix}$$

where E_{G} is the magnitude of the internal voltage of the power generator, δ_{EG} is the phase angle of the internal voltage of the power generator, X is the internal reactance of the power generator, V_{T} is the magnitude of the power generator terminal voltage, δ_{VT} is the phase angle of the power generator terminal voltage, P_{G} is the power generator active power output, I_{G} is the power generator output current (complex number). The output I_{Gref} of the power generator characteristic computation unit 20 corresponds to I_{G} in expression (1) and δ_{EG} corresponds to the product (ωt) of the angular frequency ω and the time.

When the angular frequency i.e. the angular frequency ω of the power system 1 drops, due to for example increased load, the angular frequency ω is controlled so as to return to the vicinity of the fundamental angular frequency ω₀, by the action of the mechanical output computation section 9 and the rotor speed computation section 10, so δ_{EG}−δ_{VT} becomes large and P_{G} is increased. I_{G} and P_{G} correspond to the current and the active power supplied to the power system 1. Consequently, when the angular frequency of the power system 1, i.e. the angular frequency ω drops due to increase in load or the like, the action is such as to suppress such lowering of the angular frequency of the power system 1.

Conversely, when the angular frequency of the power system 1, i.e. the angular frequency ω, rises due for example to diminution in the load, δ_{EG}-δ_{VT} becomes smaller, so supply of power to the power system 1 is decreased, i.e. the action is such as to suppress such elevation of the angular frequency of the power system 1.

E_{G} shown in expression (1) and expression (2) changes in the same direction as the value Efd corresponding to the field voltage which is output by the field voltage computation section 12, so when the voltage of the power system 1 drops, the value Efd corresponding to the field voltage becomes larger and E_{G} also becomes larger: this therefore acts so as to suppress voltage drop of the power system 1. Conversely, when the voltage of the power system 1 rises, the value Efd corresponding to the field voltage becomes smaller and E_{G} also becomes smaller, so this acts to suppress elevation of the voltage of the power system 1.

Next, the action in the steady condition in which the voltage and angular frequency of the power system are stable will be described. The power generated by the photovoltaic module 3 changes depending on the amount of solar radiation, so the power that is supplied to the power system 1 from the first electric power converter 2A also changes depending on the amount of solar radiation. Usually, the voltage of the connection point (point a) does not depart much from the reference value, so, since the power is the product of voltage and current, the change of power in the steady condition is substantially the same as the change in current, and may therefore be represented by the output value I_{PV} of the first current detector 6A. In the steady condition, the output value I_{Gref} of the power generator characteristic computation unit 20 is equivalent to a synchronous power generator of fixed output and is therefore fixed. The second power conversion controller 14B performs control such that a current corresponding to the difference of the output value I_{Gref} of the power generator characteristic computation unit 20 and the output value I_{PV} of the first current detector 6A flows from the second electric power converter 2B to the power system 1. As a result, the total value of the supplied power from the photovoltaic module 3 through the first electric power converter 2A and the supplied power from the storage battery 4 through the second electric power converter 2B, i.e. the supplied power to the power system 1, is constant.

It should be noted that, if the voltage obtained by the first voltage detector 5A is not automatically controlled to a specified value i.e. if voltage fluctuation due to increase/decrease of the active power etc is permitted, the field voltage computation section 12 could be dispensed with, by setting the value Efd corresponding to the field voltage by the voltage setting section 11.

Also, when suppression of fluctuation of the angular frequency ω is unnecessary, only suppression of fluctuation of the characteristic of the synchronous power generator on its own being necessary, the mechanical output computation section 9 can be dispensed with by using the active power setting section 8 to set the mechanical output Tm.

With the photovoltaic system according to the present embodiment, the second power conversion controller 14B controls the output current I_{G} of the second electric power converter 2B using: kinetic motion equation of the synchronous power generator and electrical characteristic expression (Park's equation); the governor, which constitutes the control device of the synchronous power generator; and the difference of the output I_{Gref} of the power generator characteristic computation unit 20 that calculates the characteristic of the excitation system and the output I_{PV} of the current detector 6A that corresponds to the power supplied to the power system 1 from the photovoltaic module 3 through the first electric power converter 2A. In this way, the total of the power supplied to the power system 1 from the first electric power converter 2A and the second electric power converter 2B is equivalent to that of a synchronous power generator in regard to change of voltage and angular frequency of the power system 1. Also, the power system can be treated in the same way as a synchronous power generator, since it can be used in the same way as a synchronous power generator in regard to for example output of active power as scheduled.

Thus, with a power supply system according to the embodiment described above, by conferring the same characteristics as a synchronous power generator on a power generation system representing a combination of power generation equipment utilizing renewable energy such as photovoltaic and a power storage device such as an storage battery, the power system can be treated in the same way as a synchronous power generator from the point of view of monitoring and control of the system as a whole, so a power supply system can be provided that is capable of stable power supply when systems linked with the power system are operated.

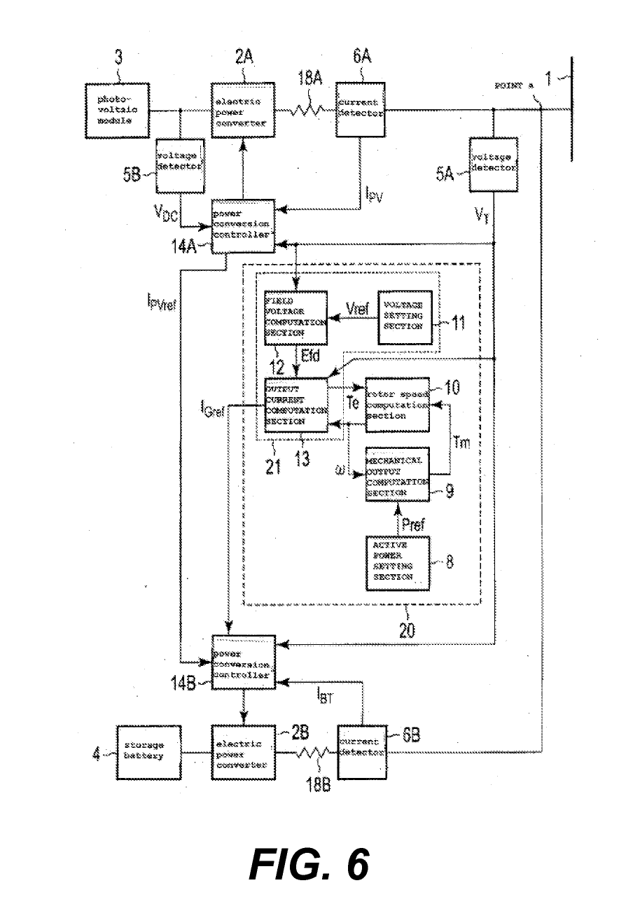

FIG. 6 is a block diagram showing another layout example of a power supply system according to the first embodiment. In the following description, items which are the same as in the case of the power supply system of the first embodiment described above are given the same reference symbols to avoid duplicated description.

In the case of the power supply system shown in FIG. 6, the input of the second power conversion controller 14B is the output I_{PVref} of the first power conversion controller 14A, rather than the output of the first current detector 6A. Otherwise, this power supply system is the same as the power supply system shown in FIG. 1.

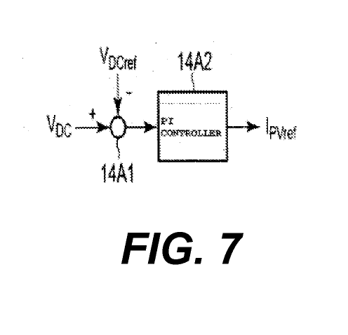

FIG. 7 is a view showing an example of a block diagram for finding the current instruction value I_{PVref}. The first power conversion controller 14A is provided with a subtractor 14A1 that subtracts a voltage instruction value V_{DCref} from the voltage V_{DC} and a PI controller 14A2 that outputs a current instruction value I_{PVref} such that the difference of the voltage V_{DG} and the voltage instruction value V_{DCref} becomes zero. When the output power from the photovoltaic module 3 becomes large, the voltage V_{DG} detected by the second voltage detector 5B becomes high, and the current instruction value I_{PVref} also becomes large. The output current I_{G} of the first electric power converter 2A is controlled so as to be equal to the current instruction value I_{PVref}, so, if the voltage is roughly fixed, the output power of the first electric power converter 2A also becomes large. Contrariwise, if the output power from the photovoltaic module 3 becomes small, V_{DG} detected by the second voltage detector 5B becomes low, so the current instruction value T_{PVref} and the output power of the first electric power converter 2A also become small.

As described above, the current instruction value I_{PVref} and the output value I_{PV} of the first current detector 6A are substantially the same, so, even if the current instruction value I_{PVref} is employed as the input of the second power conversion controller 14B, instead of the output from the first current detector 6A, the same beneficial effect as in the case of the embodiment described above is obtained.

Next, a power supply system according to a second embodiment will be described in detail with reference to the drawings.

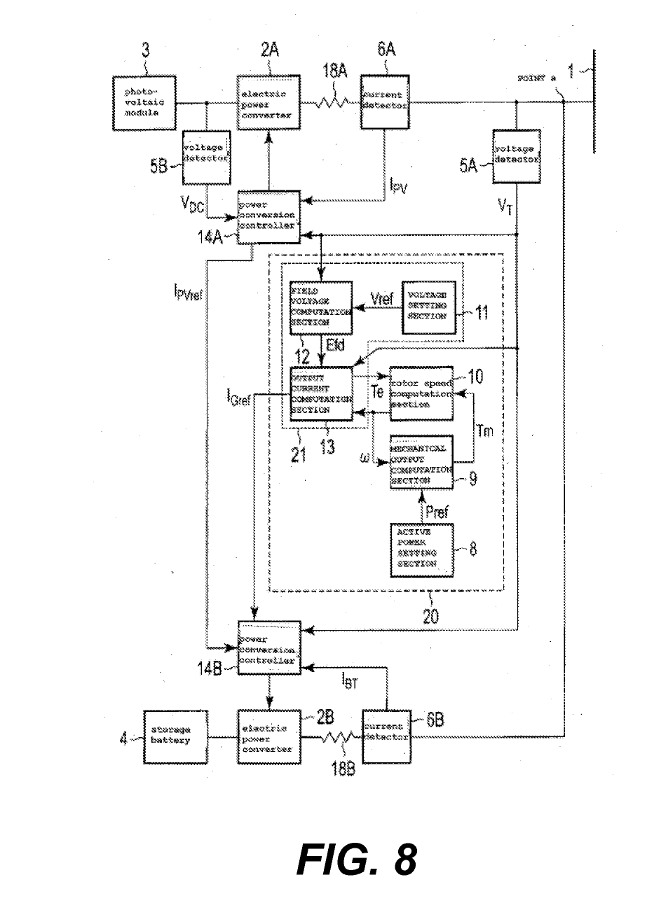

FIG. 8 is a block diagram showing diagrammatically an example layout of a power supply system according to the second embodiment.

The construction of the electrical characteristic computation section 21 of the power generator characteristic computation unit 20 of the power supply system according to this embodiment differs from that of the power supply system of the first embodiment described above.

The electrical characteristic computation section 21 comprises: a voltage setting section 11; an internal voltage computation section 15 whereby a set value V_{ref} that is output from the voltage setting section 11 and a voltage (near end voltage) V_{T} that is output from the first voltage detector 5A are supplied; and a simplified current computation section 16 that is supplied with the output value E_{G} of the internal voltage computation section 15, the output value ω of the rotor speed computation section 10 and the output value V_{T} of the first voltage detector 5A. The output of the electrical characteristic computation section 21 i.e. the output value I_{G2} of the simplified current computation section 16, is supplied to the second power conversion controller 14B.

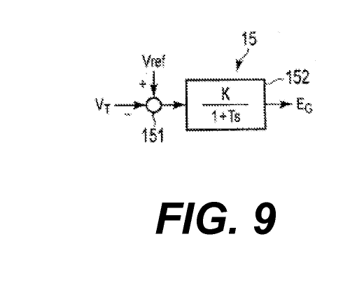

FIG. 9 is a block diagram showing diagrammatically an example layout of the internal voltage computation section 15.

The internal voltage computation section 15 comprises: a subtractor 151 for example constituted so as to implement the transfer function shown in FIG. 9 and that outputs the difference obtained by subtracting the near end voltage V_{T} from the set value V_{ref}, and a first-order lag block 152 of time constant T. The internal voltage computation section 15 calculates the internal voltage E_{G} of the virtual power generator that makes the near end voltage V_{T}, which is the output of the first voltage detector 5A, equal to the set value V_{ref}, which is the output of the voltage setting section 11.

The simplified current computation section 16 calculates the output current I_{G2} of the virtual power generator from the output value E_{G} of the internal voltage computation section 15, the output value ω of the rotor speed computation section 10, and the output value V_{DC} of the first voltage detector 5A. As an example, the output current I_{G2} is obtained by expression (1) given above; δ_{VT} is obtained by an ordinary synchronized phase detector (PLL: Phase-Locked Loop); and δ_{EG} is obtained by the following expression (3).

[Math 3]

δ_{EG}=ω₀∫ωdt (3)

The output current I_{PV} of the photovoltaic module 3 through the first electric power converter 2A, the output current I_{G2} of the virtual power generator, the output value V_{DC} of the first voltage detector 5A, and the output value I_{BT} of the second current detector 6B are supplied to the second power conversion controller 14B; the second power conversion controller 14B controls the second electric power converter 2B so that the output value I_{BT} of the second current detector 6B, which is the output current of the storage battery 4 through the second electric power converter 2B, is equal to the difference of the output current I_{G2} of the virtual power generator and the output current I_{PV} of the first electric power converter 2A. As a result, the current, i.e. power, supplied to the power system 1 from the connection point (point a) is the same as that of a virtual power generator.

It should be noted that, if the voltage obtained by the first voltage detector 5A is not automatically controlled to a set value i.e. if voltage fluctuation produced by increase/decrease of active power is permitted, the internal voltage computation section 15 can be dispensed with by setting the internal voltage E_{G} of the virtual power generator, by using the voltage setting section 11.

Also, when suppression of fluctuation of the angular frequency ω is unnecessary, only suppression of fluctuation of the characteristic of the synchronous power generator on its own being necessary, the mechanical output computation section 9 can be dispensed with by using the active power setting section 8 to set the mechanical output Tm.

As described above, by simplifying the content of processing by the power generator characteristic computation unit 20 that simulates the characteristics of a synchronous power generator, characteristics that are close to those of a synchronous power generator can be conferred on a power supply system by a small amount of computation. Also, the power supply system can be treated in the same way as a synchronous power generator, since operation is the same as that of a synchronous power generator in regard to for example output of active power in accordance with scheduling.

Specifically, with a power supply system according to this embodiment, a power supply system can be provided that is capable of being treated in the same way as a synchronous power generator from the point of view of monitoring and control of the power system as a whole.

Next, a power supply system according to a third embodiment will be described in detail with reference to the drawings.

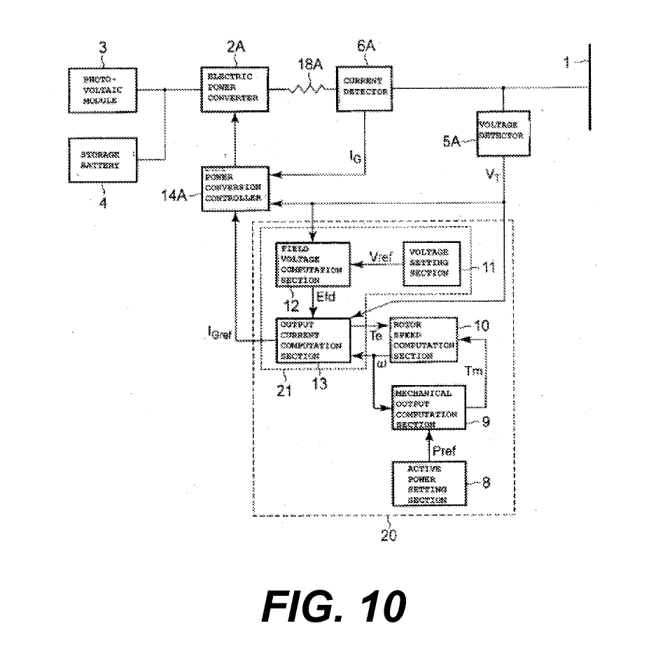

FIG. 10 is a block diagram showing diagrammatically an example of the layout of a power supply system according to the third embodiment.

The power supply system according to this embodiment differs from the power supply system according to the first embodiment described above in regard to the position of connection of the storage battery 4 and the destination to which the output value of the power generator characteristic computation unit 20 is supplied.

The storage battery 4 is connected to the photovoltaic module 3 and to the first electric power converter 2A.

Specifically, the total of the power generated by the photovoltaic module 3 and the charging/discharging power from the storage battery 4 is converted to AC power by the first electric power converter 2A, before being supplied to the power system 1. The power supply system of this embodiment therefore does not comprise a second power conversion controller 14B, second electric power converter 2B or second current detector 6B. However, it should be noted that, in the power supply system of this embodiment, control is exercised so that the DC voltage to the first power conversion controller 14A is constant between the photovoltaic module 3 and the storage battery 4, as will be described later. Consequently, in the power supply system of this embodiment, no second voltage detector 5B is provided.

The power generator characteristic computation unit 20 has the same construction as in the power supply system of the first embodiment, and the power generator characteristic computation unit 20 calculates an command value I_{Gref} corresponding to the output current of the virtual power generator. The output value (command value) I_{Gref} of the power generator characteristic computation unit 20 is supplied to the first power conversion controller 14A.

The first power conversion controller 14A controls the output voltage of the first electric power converter 2A so that the output current IG of the first electric power converter 2A detected by the first current detector 6A and the command value I_{Gref} are equal, so the power that is supplied to the power system 1 from the photovoltaic module 3 and the storage battery 4 through the first electric power converter 2A is equal to that of a virtual power generator.

The photovoltaic module 3 and the storage battery 4 include a control device whereby the output power from the photovoltaic module 3 is controlled to a maximum, depending on the solar radiation amount (MPPT control), and the output power from the storage battery 4 is controlled so that the DC voltage is constant.

If the output power to the power system 1 from the first electric power converter 2A is larger than the output power from the photovoltaic module 3, the DC voltage to the first electric power converter 2A drops, so, in order to raise the DC voltage, power is supplied from the storage battery 4 (i.e. it is discharged).

Conversely, if the output power from the photovoltaic module 3 is larger than the output power to the power system 1, the DC voltage rises, so, in order to lower the DC voltage, power is absorbed by the storage battery 4 (i.e. it is charged). In this way, the difference between the power corresponding to the command value I_{Gref} and the power generated by the photovoltaic module 3 is made up by charging/discharging of the storage battery 4.

As described above, even in the case where the DC voltage to the first electric power converter 2A is controlled to be constant by connecting the photovoltaic module 3 and the storage battery 4 to the first electric power converter 2A, the first power conversion controller 14A controls the output voltage of the first electric power converter 2A in such a way that the output current I_{G} of the first electric power converter 2A detected by the first current detector 6A and the command value I_{Gref} are equal: in this way, the same characteristics as a synchronous power generator can be conferred on a power generation system combining power generation equipment utilizing renewable energy such as photovoltaic and a power storage device such as an storage battery.

That is, with this embodiment, the power system can be treated in the same way as a synchronous power generator from the point of view of monitoring and control of the system as a whole, so a power supply system can be provided that is capable of stable power supply when systems linked with the power system are operated.

Next, a power supply system according to a fourth embodiment will be described in detail with reference to the drawings.

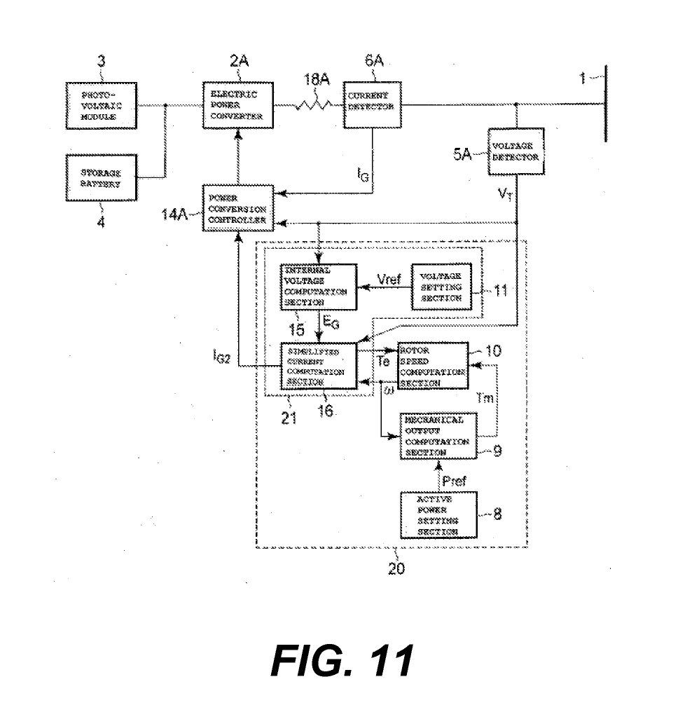

FIG. 11 is a block diagram showing diagrammatically an example layout of a power supply system according to the fourth embodiment.

The power supply system according to this embodiment differs from the power supply system according to the second embodiment in regard to the position of connection of the storage battery 4 and the destination of supply of the output value of the power generator characteristic computation unit 20.

The storage battery 4 is connected with the photovoltaic module 3 and the first electric power converter 2A. Specifically, the total of the power generated by the photovoltaic module 3 and the charging/discharging power of the storage battery 4 is converted to AC power by the first electric power converter 2A before being supplied to the power system 1. Consequently, the power supply system of this embodiment does not comprise a second power conversion controller 14B, second electric power converter 2B or second current detector 6B. However, it should be noted that, in the power supply system of this embodiment, control is exercised so that the DC voltage to the first power conversion controller 14A is constant between the photovoltaic module 3 and the storage battery 4, as will be described later. Consequently, in the power supply system of this embodiment, no second voltage detector 5B is provided.

The power generator characteristic computation unit 20 has the same construction as the power supply system of the second embodiment; the power generator characteristic computation unit 20 calculates an command value I_{G2} corresponding to the output current of the virtual power generator. The output value (command value) I_{G2} of the power generator characteristic computation unit 20 is supplied to the first power conversion controller 14A.

Since the first power conversion controller 14A controls the output voltage of the first electric power converter 2A so that the output current I_{G} of the first electric power converter 2A that is detected by the first current detector 6A and the command value I_{G2} are equal, the power that is supplied to the power system 1 from the photovoltaic module 3 and the storage battery 4 through the first electric power converter 2A is equal to that of a virtual power generator.

Also, just as in the case of the third embodiment, the photovoltaic module 3 and the storage battery 4 include control devices, so that the difference of the power corresponding to the command value I_{G2} and the power generated by the photovoltaic module 3 is made up by charging/discharging of the storage battery 4.

As described above, even in the case where the DC voltage to the first electric power converter 2A is controlled to be constant by connecting the photovoltaic module 3 and the storage battery 4 to the first electric power converter 2A, the first power conversion controller 14A controls the output voltage of the first electric power converter 2A in such a way that the output current I_{G} of the first electric power converter 2A detected by the first current detector 6A and the command value I_{G2} are equal: in this way, the same characteristics as a synchronous power generator can be conferred on a power generation system combining power generation equipment utilizing renewable energy such as solar power and a power storage device such as an storage battery.

Specifically, with this embodiment, a power supply system can be provided wherein it is possible to treat the power system equivalently to a synchronous power generator, from the point of view of monitoring and control of the power system as a whole, so as to achieve stable power supply even when other systems are operated in linked fashion with the power system.

While various embodiments of the present invention have been described, these embodiments are presented merely by way of example and are not intended to restrict the scope of the invention. Novel embodiments may be put into practice in various other ways, and various deletions, substitutions or alterations may be performed without departing from the gist of the invention. Such embodiments or modifications thereof are included in the scope and gist of the invention and are included in the invention as set out in the claims and equivalents thereof.

What is claimed is:

1. A power supply system comprising:
electric power storage means;
a second electric power converter that converts power discharged by said electric power storage means to AC power and that converts charging power to said electric power storage means to DC power;
a second current detector that detects a current that is output from said second electric power converter;
a first electric power converter that converts DC power to AC power and supplies said AC power;
an electric characteristic computation section that calculates an output current and an electrical output torque of a virtual power generator, based on a voltage, angular frequency and voltage set value of a connection point between said second electric power converter and said power supply system;
a rotor speed computation section that calculates said angular frequency of said virtual power generator, based on said electrical output torque of said virtual power generator calculated by said electrical characteristic computation section and an output target value for active power; and
a second power conversion controller that controls said second electric power converter in accordance with a difference of a current that is output to said power system from said first electric power converter and an output current of said virtual power generator.

2. A power supply system comprising:
electric power storage means;
a second electric power converter that converts power discharged by said electric power storage means to AC power and that converts charging power to said electric power storage means to DC power;
a second current detector that detects a current that is output from said second electric power converter;
a first electric power converter that converts DC power to AC power and supplies said AC power;
an electric characteristic computation section that calculates an output current and an electrical output torque of a virtual power generator, based on a voltage, angular frequency and voltage set value of a connection point between said second electric power converter and said power supply system;
a rotor speed computation section that calculates said angular frequency of said virtual power generator, based on said electrical output torque of said virtual power generator calculated by said electrical characteristic computation section and an output target value for active power; and
a second power conversion controller that controls said second electric power converter in accordance with a difference of an command value of an output current of said first electric power converter and an output current of said virtual power generator.

3. The power supply system according to claim 1 or claim 2,
wherein said electric power storage means is an storage battery that is charged by and that discharges DC power.

4. A power supply system comprising:
an electric characteristic computation section that calculates an output current and an electrical output torque of a virtual power generator, based on a voltage, angular frequency and voltage set value of a connection point between a first electric power converter that converts DC power to AC power and supplies said AC power and a power supply system;
a rotor speed computation section that calculates said angular frequency of said virtual power generator, based on said electrical output torque of said virtual power generator calculated by said electrical characteristic computation section and an output target value for active power; and
a first power conversion controller that controls said first electric power converter in accordance with a difference of a current that is output to said power system from said first electric power converter and an output current of said virtual power generator.

5. The power supply system according to claim 1, claim 2 or claim 4, further comprising a first voltage detector that detects the voltage of said connection point,
wherein said electrical characteristic computation section comprises:
a field voltage computation section that calculates a value corresponding to a field voltage, based on a voltage set value and a voltage detected by said first voltage detector; and
an output current computation section that calculates said electrical output torque and said output current of said virtual power generator, based on a value corresponding to said field voltage and said angular frequency, and a voltage detected by said first voltage detector.

6. The power supply system according to claim 1, claim 2 or claim 4, further comprising a first voltage detector that detects a voltage of said connection point,
wherein said electrical characteristic computation section comprises:
an internal voltage computation section that calculates an internal voltage of said virtual power generator so as to make a voltage detected by said first voltage detector and said voltage set value equal; and
an output current computation section that calculates said electrical output torque and said output current of a virtual power generator, based on a voltage detected by said first voltage detector and said angular frequency, and said internal voltage.

7. The power supply system according to claim 1, claim 2 or claim 4, further comprising a mechanical output computation section that calculates a mechanical output of said virtual power generator, based on a set value of said active power and said angular frequency,
wherein said rotor speed computation section calculates said angular frequency of said virtual power generator based on said mechanical output and said electrical output torque.
